(19) United States
(12) Patent Application Publication
(10) Pub. No.: US 2026/0184253 A1
(43) Pub. Date: Jul. 2, 2026

(54) PLANETARY ROLLER SCREW ACTUATED VEHICLE SLIDING SYSTEMS

(71) Applicant: Xinfang Zhang

(72) Inventor: Xinfang Zhang

(21) Appl. No.: 19/006,200

(22) Filed: Dec. 30, 2024

(51) Int. Cl. B60P 3/34

(52) U.S. Cl. CPC B60P 3/34

(57) ABSTRACT

This application pertains to a planetary roller screw actuated vehicle compartment sliding system, comprising: sliding compartment, planetary roller screw motion assembly, drive unit, support frame, load-bearing box. The planetary roller screw motion assembly, drive unit, and part of the support frame are symmetrically integrated within the load-bearing box. The load-bearing boxes are symmetrically set at the lower part of both sides of the sliding compartment. Installation only requires fixing the base plate of the support frame to the vehicle body, thereby securing the entire sliding compartment at the vehicle's opening. The bottom of each load-bearing box features a long slot, allowing the two symmetrical load-bearing boxes to slide back and forth synchronously. This application enables the extension and retraction of the vehicle compartment, increasing the usable space within the vehicle. This design ensures a neat and aesthetically pleasing appearance while facilitating easy installation and removal.

### TECHNICAL FIELD

The invention relates to the technical field of vehicle interior space expansion, and in particular relates to a planetary roller screw actuated vehicle compartment deployment system.

### PRIOR ART

Existing vehicles and motorhomes are equipped with a slide-out compartment to increase the interior space of the motorhome. The outer wall of the slide-out compartment is flush with the exterior of the vehicle or trailer during traveling, and when the vehicle stops, the slide-out chamber is slid outwardly from an opening in the vehicle, thereby increasing the interior space of the vehicle.

Patent No. CN202111541306.4 discloses a caravan expansion mechanism and a caravan, wherein the slide-out mechanism is located underneath and on both sides of the body of the vehicle, has no integrated setup, occupies a large amount of space, is inconvenient to install, and does not run smoothly.

Patent No. US202117408020A discloses a slide-out mechanism set on both sides of a slide-out compartment, due to the complexity of the mechanism used, the height of the telescopic drive device is too high, occupies a large space, is inconvenient to maintain, and increases the cost of use.

With respect to the above related technology, the inventor believes that the slide-out mechanism of the vehicle box slide-out system is relatively large, complicated to install, and costly. Therefore, it is believed that the slide-out mechanism of the vehicle box slide-out system occupies a large space.

### SUMMARY OF THE INVENTION

In order to optimize interior space and enhance living comfort, this design focuses on reducing the space occupied by the expansion mechanism. By employing a compact planetary roller screw actuated system, it achieves both efficient operation and minimal intrusion into the living area. The system is integrated at the lower part of both sides of the compartment, suspending and supporting the weight of the sliding compartment. The compact design maximizes interior space utilization by minimizing the footprint of the deployment mechanism. The entire sliding mechanism is integrated and connected to the support frame's base plate. This design eliminates the need for disassembling the vehicle's lower chassis, making installation and removal straightforward. Simply securing the support frame's base plate to the vehicle body allows the entire sliding compartment to be set at the vehicle's opening.

### DETAILED DESCRIPTION OF THE PREFERRED EMBODIMENTS

In order to realize the above purpose, the present invention adopts the following technical solution:

A planetary roller screw actuated vehicle expansion system, comprising a sliding compartment, a planetary roller screw motion assembly, a drive unit, a support frame, and a load-bearing box. The sliding compartment is positioned at the vehicle's opening. The planetary roller screw motion assembly is mounted on top of the support frame, while the drive unit is fixed at the uppermost part inside the load-bearing box. The planetary roller screw motion assembly, drive unit, and part of the support frame are integrated within the load-bearing box. The load-bearing boxes are symmetrically installed at the lower part of both sides of the sliding compartment. The bottom of each load-bearing box features a long slot through which it slides along the lower part of the support frame.

By adopting this technical solution, the integration of the planetary roller screw motion assembly, drive unit, and part of the support frame within the load-bearing box isolates these components from external influences. This design facilitates easy installation and removal, ensures an aesthetically pleasing appearance, and increases the internal usable space of the vehicle.

Preferably, the planetary roller screw motion assembly includes screw shaft, first planetary roller nut, second planetary roller nut, circlip, first nut flange, second nut flange, large gear, first flange, second flange, first bearing, second bearing. The screw shaft engages with both the first and second planetary roller nuts. One end of the screw shaft is supported by the first bearing, which is fixed to the first flange, while the other end is supported by the second bearing, which is fixed to the second flange. Near the end of the screw shaft adjacent to the second bearing, there is a large gear attached. A circlip is fixed at one end of the screw shaft. The screw shaft performs spiral motion inside the first and second planetary roller nuts. The first planetary roller nut has first nut connection holes. The second planetary roller nut has second nut connection holes. The first flange has first flange connection holes. The second flange has second flange connection holes.

By adopting the aforementioned technical solution, the large gear drives the screw shaft to perform spiral motion within the first and second planetary roller nuts. The screw shaft rotates along its central axis. Through the forward and reverse rotation of the screw shaft, the sliding compartment can be extended and retracted. The weight of the sliding compartment is supported by the first and second flanges, which then transfer this weight to the screw shaft. The screw shaft subsequently transfers the load to the first and second planetary roller nuts.

Preferably, the drive assembly includes drive bracket, motor, reducer, pinion gear, first Circlip, second circlip, synchronous belt. The output shaft of the motor is connected to the reducer, which is mounted on the drive bracket. The output shaft of the reducer is connected to the pinion gear. The first and second circlips are fixed on the output shaft of the reducer to secure the pinion gear in place. The motor, through the reducer, drives the rotation of the pinion gear. The synchronous belt connects the pinion gear and the large gear, ensuring synchronized transmission between them.

By adopting the aforementioned technical solution, the pinion gear drives the large gear on the screw shaft via the synchronous belt, thereby actuating the planetary roller screw motion assembly.

Preferably, the drive bracket features reducer mounting holes. The reducer has corresponding reducer connection holes that align with the reducer mounting holes on the drive bracket. The top of the drive bracket is equipped with mounting holes. The top of the load-bearing box is fitted with drive bracket mounting holes that correspond to the mounting holes on the drive bracket.

Through this technical solution, the reducer is securely mounted on the drive bracket, which in turn is fixed to the top interior of the load-bearing box.

Preferably, the support frame includes nut mounting bracket, vertical plate, base plate. The nut mounting bracket has first nut mounting holes on one side that corresponds to first nut connection holes. Second nut mounting holes on the other side that corresponds to second nut connection holes. The base plate features support frame connection holes.

By adopting this technical solution, the first and second planetary roller nuts transfer the load to the nut mounting bracket. The nut mounting bracket then transfers the load to the support frame. Finally, the support frame transfers the load to the vehicle body. A long slot in the bottom of the load-bearing box slides over the vertical plates of the support frame. The base plate supports the entire sliding compartment without requiring disassembly of the vehicle's chassis. The support frame's base plate can be directly fixed to the vehicle body. The entire sliding compartment is suspended at the vehicle's opening, with the support frame transferring the weight of the sliding compartment to the vehicle body.

Preferably, the load-bearing box features a load-bearing inspection panel at one end. A load-bearing panel at the other end.

By adopting this technical solution, the load-bearing inspection panel and load-bearing panel transfer the weight of the sliding compartment through the first and second flanges to the screw shaft. The screw shaft then transfers the load to the first and second planetary roller nuts. The first and second planetary roller nuts transfer the load to the nut mounting bracket. The nut mounting bracket transfers the load to the support frame, which finally transfers it to the vehicle body.

Preferably, the load-bearing inspection panel is removable. It is installed and removed using load-bearing inspection panel connection holes and load-bearing inspection panel mounting holes.

By adopting the aforementioned technical solution, installation is simplified. When faults occur within the load-bearing box, the load-bearing inspection panel can be removed for maintenance, thereby reducing repair costs.

Preferably, the load-bearing inspection panel has second flange mounting holes that correspond to the second flange connection holes. The load-bearing panel has first flange mounting holes that correspond to the first flange connection holes.

By adopting this technical solution, the first flange can be fixed to the load-bearing panel using the first flange mounting holes. The second flange can be fixed to the load-bearing inspection panel using the second flange mounting holes. The load-bearing inspection panel and load-bearing panel transfer the weight of the sliding compartment to the first and second flanges.

Preferably, during vehicle operation, the sliding compartment aligns flush with the exterior plane of the vehicle body.

This configuration minimizes the impact of external environmental factors on the interior of the vehicle and ensures an aesthetically pleasing appearance.

In Summary, this application includes at least one of the following Beneficial technical effects:

The planetary roller screw motion assembly, drive unit, and part of the support frame are integrated and symmetrically installed in the load-bearing boxes located at the lower part of both sides of the sliding compartment. This design enables synchronized back-and-forth sliding, thereby increasing the usable interior space of the vehicle.

By integrating the planetary roller screw motion assembly, drive unit, and part of the support frame within the load-bearing boxes, this configuration isolates these components from external influences, reducing the internal space they occupy.

Since the entire sliding mechanism inside the load-bearing box is integrated and connected to the base plate of the support frame, there is no need to disassemble the vehicle's lower chassis. Installation and removal are simplified by simply securing the support frame's base plate to the vehicle body, allowing the entire sliding compartment to be set at the vehicle's opening.

The load-bearing inspection panel on the load-bearing box is removable. In case of internal faults within the load-bearing box, the load-bearing inspection panel can be removed for maintenance, facilitating repairs and reducing maintenance costs.

The sliding compartment aligns flush with the exterior plane of the vehicle body during operation. This design minimizes the impact of external environmental factors on the interior of the vehicle and ensures an aesthetically pleasing appearance.

### BRIEF DESCRIPTION OF THE DRAWINGS

To clearly illustrate the technical solutions of this invention, the following provides a simple introduction to the drawings used in the description. It should be understood that the drawings described below are merely some embodiments of this invention. Based on these drawings, those skilled in the art can obtain other drawings without making creative efforts.

FIG. 1 is a perspective view of the sliding compartment extended from the vehicle's opening.

FIG. 2 is a perspective view of the sliding compartment fully retracted into the vehicle's opening.

FIG. 3 is a front sectional view of the sliding compartment.

FIG. 4 is a structural diagram of the sliding mechanism.

FIG. 5 is an exploded view of the planetary roller screw motion assembly.

FIG. 6 is an exploded view of the drive unit.

FIG. 7 is a structural diagram of the support frame.

FIG. 8 is a structural diagram of the load-bearing box.

FIG. 9 is an exploded view of the sliding mechanism.

FIG. 10 is a front sectional view of the interior of the load-bearing box.

FIG. 11 is a demonstration diagram of a sliding compartment sliding out, wherein the 11A is a perspective view of the sliding compartment fully extended; 11B is a side view of the sliding compartment fully extended; 11C is a sectional view of the sliding mechanism when the compartment is fully extended.

FIG. 12 is a demonstration diagram of a sliding compartment retraction, wherein the 12A is perspective view of the sliding compartment fully retracted; 12B is side view of the sliding compartment fully retracted; 12C is sectional view of the sliding mechanism when the compartment is fully retracted.

### BRIEF DESCRIPTION OF THE FIGURES

Follow are the reference numbers appear in the drawings:
1. Sliding Compartment
2. Load-bearing Box
3. Support Frame, 303. Vertical Plate, 302. Base Plate
4. Synchronous Belt
5. Screw Shaft
6a. First Planetary Roller Nut, 6b. Second Planetary Roller Nut
7. Circlip
8. Nut Mounting Bracket, 8a. First Nut Flange, 8b. Second Nut Flange
9. Motor
10. Reducer
11. Drive Bracket
12. Large Gear
13. Pinion Gear
14. Load-bearing Inspection Panel
15. Load-bearing Panel
16. Long Slot
17a. First Flange
17b. Second Flange
18a. First Bearing, 18b. Second Bearing
19. Second Flange Mounting Hole
20. First Flange Mounting Hole
21. Drive Bracket Mounting Hole
22. Mounting Hole
23a. First Nut Connection Hole, 23b. Second Nut Connection Hole
24a. First Nut Mounting Hole, 24b. Second Nut Mounting Hole
25. Vehicle Body
26a. First Flange Connection Hole, 26b. Second Flange Connection Hole
27. Reducer Mounting Hole
28. Reducer Connection Hole
29a. First Circlip, 29b. Second Circlip
30. Planetary roller screw Motion Assembly
31. Load-bearing Inspection Panel Mounting Hole
32. Load-bearing Inspection Panel Connection Hole
33. Support Frame Connection Hole
34. Drive Unit

### DETAILED DESCRIPTION OF THE INVENTION

To make the objectives, features, and advantages of this invention more apparent and understandable, the following describes the technical solutions of the invention in detail with reference to the accompanying drawings of the specific embodiments. It is evident that the embodiments described below are only part of the embodiments of this invention and not all of them. Based on the embodiments of this patent, all other embodiments obtained by those skilled in the art without making any inventive effort fall within the scope of protection of this patent.

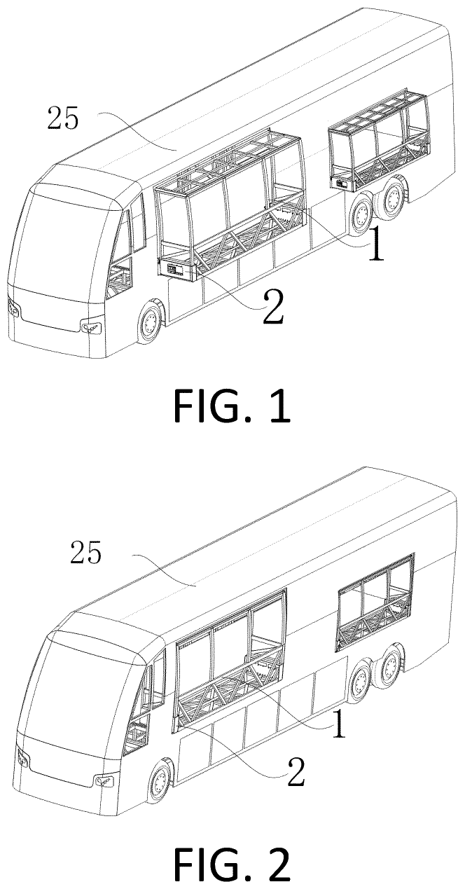

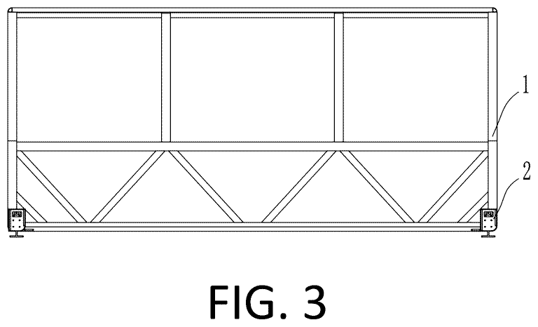

Referring to FIGS. 1-2, it can be seen that when the vehicle is stationary, the sliding compartment 1 completely slides out from the opening on the vehicle body 25, increasing the usable space inside the vehicle body 25. After the sliding compartment 1 is retracted, it aligns flush with the appearance of the vehicle body 25, not affecting the overall aesthetic effect.

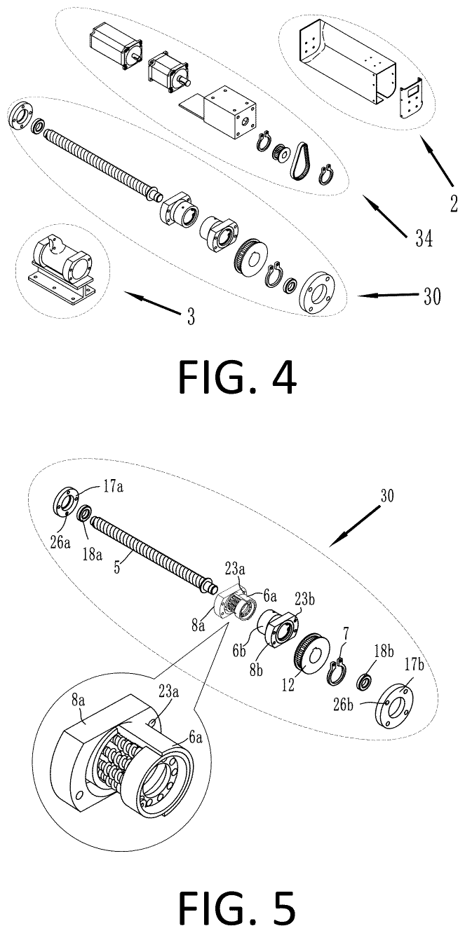

As shown in FIGS. 3-4, a planetary roller screw actuated vehicle compartment sliding system includes a sliding compartment 1, a planetary roller screw motion assembly 30, a drive unit 34, a support frame 3, and a load-bearing box 2. The sliding compartment 1 is made of aluminum alloy or other materials with relatively light structural rigidity. Below the relative side walls of the sliding compartment 1, there are corresponding load-bearing boxes 2, two of which have identical internal structures set correspondingly for synchronized movement, bearing the weight of the sliding compartment 1. The planetary roller screw motion assembly 30, drive unit 34, and part of the support frame 3 are integrated within the load-bearing box 2, saving space and facilitating rapid installation and removal.

As illustrated in FIG. 5, the planetary roller screw motion assembly 30 comprises the screw shaft 5, first planetary roller nut 6a, second planetary roller nut 6b, circlip 7, first nut flange 8a, second nut flange 8b, first bearing 18a, second bearing 18b, first flange 17a, second flange 17b, and large gear 12. The screw shaft 5 engages with the first screw nut 6a and second screw nut 6b, one end of which is fixed on the first flange 17a via the first bearing 18a, while the other end is fixed on the second flange 17b via the second bearing 18b. Inside the first planetary roller nut 6a and second planetary roller nut 6b, the screw shaft 5 performs spiral motion. Near the second bearing 18b, the large gear 12 is attached to the screw shaft 5, which has a circlip 7 at its end holding the large gear 12 in place. The first planetary roller nut 6a has first nut connection holes 23a, the second planetary roller nut 6b has second nut connection holes 23b, the first flange 17a has first flange connection holes 26a, and the second flange 17b has second flange connection holes 26b.

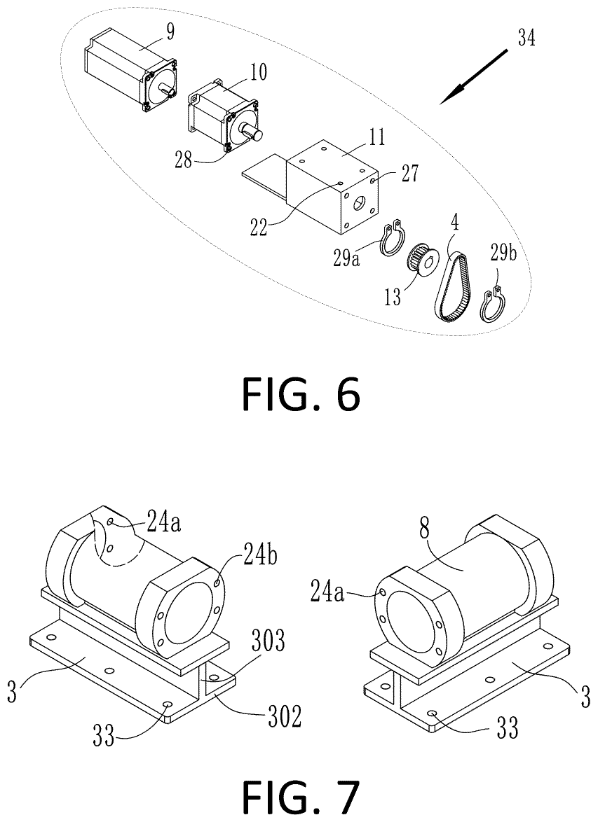

As depicted in FIG. 6, the drive unit 34 consists of a drive bracket 11, motor 9, reducer 10, pinion gear 13, first circlip 29a, second circlip 29b, and synchronous belt 4. The output shaft of the motor 9 connects to the reducer 10, where the drive bracket 11 has reducer mounting holes 27 and the reducer 10 has corresponding reducer connection holes 28. On the output shaft of the reducer 10, the pinion gear 13 is connected, with the first circlip 29a and second circlip 29b fixing the pinion gear 13 in place. The motor 9 drives the pinion gear 13 through the reducer 10, and the synchronous belt 4 connects the pinion gear 13 and the large gear 12 for synchronized transmission. The top of the drive bracket 11 has mounting holes 22 that correspond to the drive bracket mounting holes 21 on the top of the load-bearing box 2.

As shown in FIG. 7, the support frame 3 includes a nut mounting bracket 8, vertical plate 303, and base plate 302. One side of the nut mounting bracket 8 has first nut mounting holes 24a corresponding to the first nut connection holes 23a, and the other side has second nut mounting holes 24b corresponding to the second nut connection holes 23b for fixing and supporting the first planetary roller nut 6a and second planetary roller nut 6b. The base plate 302 has support frame connection holes 33 used to fix the support frame to the vehicle body 25.

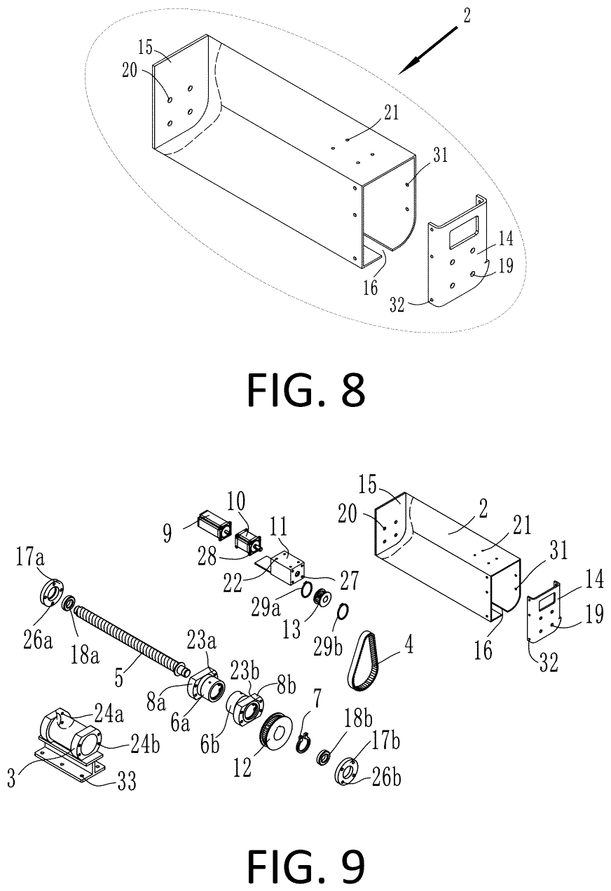

As illustrated in FIG. 8, the front and rear surfaces of the load-bearing box 2 are equipped with detachable load-bearing inspection panel 14 and load-bearing plate 15. The load-bearing inspection panel 14 has second flange mounting holes 19 corresponding to the second flange connection holes 26b, while the load-bearing plate 15 has first flange mounting holes 20 corresponding to the first flange connection holes 26a. The load-bearing inspection panel 14 is installed and removed via load-bearing inspection panel connection holes 32 and load-bearing inspection panel mounting holes 31, facilitating maintenance of the planetary roller screw motion assembly 30. The load-bearing box 2 bears the weight of the sliding compartment 1 and transfers it to the first flange 17a and second flange 17b on the load-bearing inspection panel 14 and load-bearing plate 15. A long slot opening 16 is set below the load-bearing box 2.

FIG. 9 shows the exploded view of the sliding mechanism.

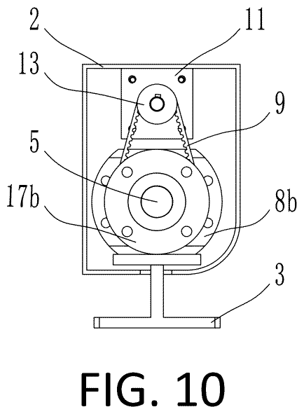

As shown in FIG. 10, the front sectional view of the interior of the load-bearing box 2 illustrates the synchronization transmission connection between the pinion gear 13 and the large gear 12 via the synchronous belt 4, as well as the connection relationship between the load-bearing box 2 and the support frame 3.

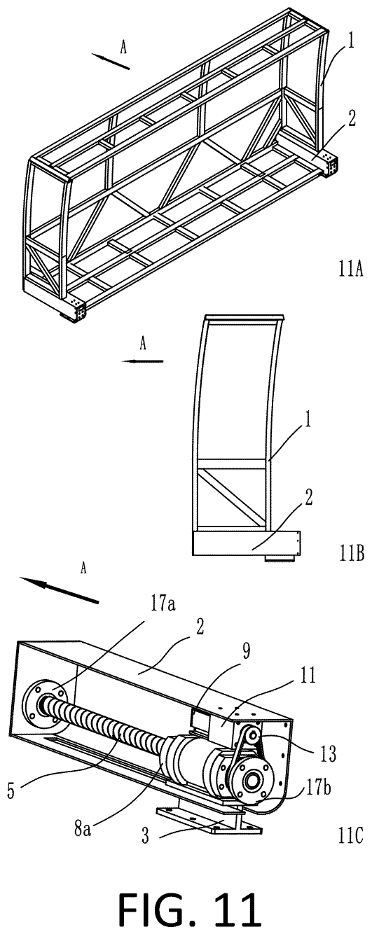

FIGS. 11a, 11b, and 11c show the extended state of the planetary roller screw actuated vehicle compartment sliding system. The motor 9 of the drive unit 34 rotates the pinion gear 13 through the reducer 10, synchronously driving the large gear 12 to rotate. The large gear 12 drives the screw shaft 5 to perform spiral motion along its central axis, moving through the first planetary roller nut 6a and second planetary roller nut 6b. This moves the load-bearing box 2 as indicated by arrow A. The first planetary roller nut 6a and second planetary roller nut 6b remain stationary, and the load-bearing box 2 pulls the sliding compartment 1 out from the opening of the vehicle body 25. Once the sliding compartment 1 fully extends to a preset length and stops, the extension process ends. The support frame 3 remains stationary, and after the sliding compartment 1 extends, the load-bearing inspection panel 14 and load-bearing plate 15 transfer the weight of the sliding compartment 1 to the screw shaft 5 through the first flange 17a and second flange 17b. The screw shaft 5 then transfers the weight to the first planetary roller nut 6a and second planetary roller nut 6b, which transfer it to the nut mounting bracket 8, which finally transfers it to the support frame 3 and ultimately to the vehicle body 25.

The load-bearing box 2 bears the weight of the planetary roller screw motion assembly 30, drive unit 34, and sliding compartment 1, transferring it through the support frame 3 to the vehicle body 25. The load-bearing inspection panel 14 is detachable; if a fault occurs inside the load-bearing box 2, the load-bearing inspection panel 14 can be removed for maintenance without needing to open the entire load-bearing box 2, facilitating future use. The planetary roller screw motion assembly 30, drive unit 34, and part of the support frame 3 except for the base plate 302 are integrated into the load-bearing box 2, saving space and enabling quick installation and removal, maintaining an aesthetically pleasing appearance.

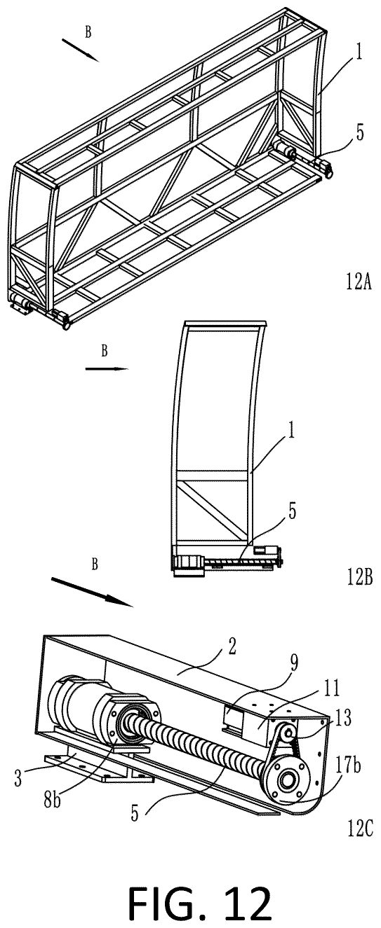

FIGS. 12a, 12b, and 12c show the retracted state of the planetary roller screw actuated vehicle compartment sliding system. The motor 9 of the drive unit 34 reversely rotates the pinion gear 13 through the reducer 10, synchronously driving the large gear 12 to rotate in reverse. The large gear 12 causes the screw shaft 5 to move in the opposite direction within the first planetary roller nut 6a and second planetary roller nut 6b, as indicated by arrow B, retracting the load-bearing box 2. The first planetary roller nut 6a and second planetary roller nut 6b remain stationary, and the screw shaft 5 rotates in the opposite direction along its central axis, pulling the load-bearing box 2 back into the vehicle. When the outer side of the sliding compartment 1 aligns flush with the vehicle body 25, the retraction stops, indicating that the sliding compartment 1 is fully retracted.

The above description of the disclosed embodiments enables those skilled in the art to implement or use this invention. Various modifications to these embodiments will be readily apparent to those skilled in the art, and the general principles defined herein may be applied to other embodiments without departing from the spirit or scope of the invention. Thus, this invention is not limited to the embodiments shown herein but is to be accorded the widest scope consistent with the principles and novel features disclosed herein.

1. A planetary roller screw actuated vehicle compartment sliding system, comprising: a sliding compartment, a planetary roller screw motion assembly, a drive unit, a support frame, a load-bearing box. wherein the sliding compartment is set at the opening of the vehicle body. The planetary roller screw motion assembly is fixed on top of the support frame, and the drive unit is mounted inside the uppermost part of the load-bearing box. The planetary roller screw motion assembly, drive unit, and part of the support frame are integrated within the load-bearing box. The load-bearing boxes are symmetrically positioned at the lower part of both sides of the sliding compartment, with a long slot at the bottom of each load-bearing box. The load-bearing boxes slide back and forth along the lower end of the support frame through these long slot openings.

2. The planetary roller screw actuated vehicle compartment sliding system according to claim 1, characterized in that: the planetary roller screw motion assembly includes: a screw shaft, a first planetary roller nut, a second planetary roller nut, a circlip, first nut flange, second nut flange, a large gear, a first flange, a second flange, a first bearing, a second bearing. The screw shaft engages with the first screw nut and the second screw nut. One end of the screw shaft is fixed to the first flange via the first bearing, while the other end is fixed to the second flange via the second bearing. Near the second bearing, the screw shaft has a large gear attached, with a circlip at its end holding the large gear in place. Inside the first planetary roller nut and second planetary roller nut, the screw shaft performs spiral motion. The first planetary roller nut has first nut connection holes, the second planetary roller nut has second nut connection holes, the first flange has first flange connection holes, and the second flange has second flange connection holes.

3. The planetary roller screw actuated vehicle compartment sliding system according to claim 2, characterized in that: the drive unit includes: a drive bracket, a motor, a reducer, a pinion gear, a first circlip, a second circlip, a synchronous belt. The output shaft of the motor connects to the reducer, which is installed on the drive bracket. On the output shaft of the reducer, the pinion gear is connected, with the first circlip and second circlip fixing the pinion gear in place. The motor drives the pinion gear through the reducer, and the synchronous belt connects the pinion gear and the large gear for synchronized transmission.

4. The planetary roller screw actuated vehicle compartment sliding system according to claim 3, characterized in that: the drive bracket has reducer mounting holes, and the reducer has corresponding reducer connection holes. The top of the drive bracket has mounting holes, and the top of the load-bearing box has drive bracket mounting holes that correspond to the mounting holes.

5. The planetary roller screw actuated vehicle compartment sliding system according to claim 4, characterized in that: the support frame includes: a nut mounting bracket, a vertical plate, a base plate. One side of the nut mounting bracket has first nut mounting holes corresponding to the first nut connection hole, and the other side has second nut mounting holes corresponding to the second nut connection holes. The base plate has support frame connection holes.

6. The planetary roller screw actuated vehicle compartment sliding system according to claim 5, characterized in that: one end of the load-bearing box is equipped with a detachable load-bearing inspection panel, and the other end is equipped with a load-bearing plate.

7. The planetary roller screw actuated vehicle compartment sliding system according to claim 6, characterized in that: the load-bearing inspection panel is removable.

8. The planetary roller screw actuated vehicle compartment sliding system according to claim 7, characterized in that: the load-bearing plate has first flange mounting holes corresponding to the first flange connection holes, and the load-bearing inspection panel has second flange mounting holes corresponding to the second flange connection holes.

9. The planetary roller screw actuated vehicle compartment sliding system according to claim 8, characterized in that: during vehicle operation, the sliding compartment aligns flush with the exterior plane of the vehicle body.
